(19) United States
(12) Patent Application Publication
(10) Pub. No.: US 2016/0082628 A1
(43) Pub. Date: Mar. 24, 2016

(54) Advanced Thermal Insulation by Pore Morphology Control in Foaming

(71) Applicant: INDUSTRIAL SCIENCE & TECHNOLOGY NETWORK, INC., Lancaster, PA (US)

(72) Inventor: Arthur Jing-min Yang, York, PA (US)

(21) Appl. No.: 14/785,226

(22) PCT Filed: Apr. 18, 2014
(86) PCT No.: PCT/US14/34663

§ 371 Date: Oct. 16, 2015

Related U.S. Application Data
(60) Provisional application No. 61/813,390, filed on Apr. 18, 2013.

(51) Int. Cl. B29C 44/34; C08J 9/00; B29C 47/30; B29C 47/00; B29C 47/14

(52) U.S. Cl. CPC B29C 44/352; B29C 47/0019; B29C 47/0004; B29C 47/14; B29C 47/30; C08J 9/0061; B29K 2025/06

(57) ABSTRACT

A foam extrusion slot die is provided, comprising a plurality of parallel dividers extending transversely across the slot, wherein the plurality of dividers define a plurality of adjacent rectangular slit openings, each having a length extending perpendicularly across the lateral length of the slot die. An article of manufacture is provided, comprising a polymer material system with at least 95% porosity comprising greater than 10%>asymmetrical pores. A method for an article of manufacture is provided comprising: extruding polymer material through an extruder die opening having an output orifice partitioned by a plurality of parallel dividers defining a plurality of adjacent slit openings each having a vertical height greater than a lateral width.

### CROSS REFERENCE TO RELATED APPLICATION

This application claims the benefit of priority from U.S. Provisional Application No. 61/813,390, filed Apr. 18, 2013. The foregoing related application, in its entirety, is incorporated herein by reference. International Application No. PCT/US2009/002693, filed May 1, 2009 and later published as International Publication WO 2009/134425, and its priority, U.S. Provisional Application No. 61/071,511, filed May 2, 2008, in their entirety, are also both incorporated herein by reference.

The work of this application was supported by grant number DE-EE0003983 from the United States Department of Energy. Thus, the U.S. government may have certain rights in this invention.

### FIELD OF THE INVENTION

The invention relates to a method of cost-effectively producing a superior thermal insulation. Thermal insulation material in the market must compete on the basis of cost per R value. The most competitive way of manufacturing low-density thermal insulation is by a foam extrusion process. In one aspect of the present invention, the foaming process is suitable to make insulation at a low cost, while creating several compositional and morphological features to significantly elevate the R-per-inch value of the foam insulation; achieving superior insulation performance with the lowest cost per R value.

### BACKGROUND OF THE INVENTION

The conventional approach of improving thermal insulation material is to reduce its density. Because air has a thermal conductivity (23 mW/M·° K) at least ten times lower than any condensed material, increasing the porosity could improve thermal resistance and lower material cost simultaneously with the increased air content. Such an approach, after so many years of practice, had reached an upper limit—material strength being reduced to near the threshold value, and more importantly, insulation value passing the maximum due to radiation heat transfer (˜20%) from excessive air content. Thus, R-value of the best foam insulations in market (with porosity as high as 97%) is in the range of R-4˜6/inch, representing the upper limit of the present foam thermal insulation technology.

A new generation of super thermal insulation, with pore sizes much smaller than those of traditional foams, may accomplish much higher insulation value (˜R-10/inch) attributed to the reduction in collisions among air molecules. Consequently, the air molecules' contribution to thermal conductivity is reduced by their entrapment within pores smaller than their mean free path of collision (in range of 100 nanometers at ambient conditions). However, with this approach of making a super insulation, the simultaneous requirements of high porosity (over 90%) and drastic pore size reduction (three orders of magnitude—from 0.1 mm to below 100 nanometers), had created a processing challenge not yet overcome in view of the high production cost. Most nanopore super thermal insulations could be produced only by a super critical drying process, which cannot compete, in terms of processing cost and speed, with what achievable by a gas foaming process.

Thermal insulations are normally installed to reduce heat flow (boost the R value) along a temperature gradient. The effective R value is equal to the insulation's rated R/inch value in that direction multiplied by its application thickness. Regardless of the overall R-value per inch rating that a new insulation may achieve, its cost per R value, after taking into account that thinner and less material is needed for same R value, must be in a range competitive to those of conventional insulation. Otherwise, very few applications would select super insulation over a thicker, yet cheaper, normal insulation; except when space restrictions may carry an extra premium for using a thinner substrate, such as insulation use in household refrigerators. The high cost per R value of the present super insulations has severely limited their penetration into a commodity insulation market.

Previous theoretical modeling work, subsequently verified by our own experiments and examples, has demonstrated the possible improvement of foam insulation value through pore size reduction, geometry creation, and pore orientation control. The idea of using pore size and morphology control to increase insulation value was first proposed by the inventor's earlier work at Armstrong (Reference 1). Later, the strategy of using them to make the 3^{rd} generation of thermal insulation was outlined in great detail (References 2 and 3). Although the most direct and effective approach to make a super insulation is to make sufficient number of nanopores, nobody could accomplish this by a foaming process and concomitantly produce a low-density nanofoam.

On the other hand, our previous foaming experiments using a pressurized vessel (shown as Example 1) had demonstrated the feasibility of using pore morphology control and orientation to lower thermal conductivity in one preferred direction (i.e. the heat flow direction) at the expense of the two other irrelevant directions normal to the heat flow direction.

### BRIEF SUMMARY OF THE INVENTION

One embodiment of the invention relates to a method of producing a new generation of advanced thermal insulation (with higher R-per-inch value) while keeping the cost (both material and manufacturing) per R value at a level competitive to present foam insulations. Another embodiment of the invention relates to the new generation advanced thermal insulation having the higher R-per-inch value.

Another embodiment of the invention relates to a method of producing a new thermal insulation product by a carbon dioxide (CO₂) foaming process so that it has the added environmental benefits of eliminating the harmful blowing agents presently consumed by foaming industry such as HFC (hydrofluorocarbon) and other Freons. In the past, vendor's resistance to the switchover from HFCs to CO₂ was based upon the faster gas exchange of the latter, which would lead to a sooner insulation value reduction from R-5/inch to R-4.2/inch after full gas exchange. Another embodiment of the invention, provides the advanced CO₂ blown thermal insulation, despite of a quick gas exchange, which is suitable for achieving an insulation value that matches, or is better than, that of an HFC in the short term, and more importantly, that increases its superiority over that of the HFC after the HFC's exchange throughout the whole insulation lifetime (30 years or longer). Furthermore, by combining both the composition and morphology modifications outlined herein, the R-value of PS foam insulation, for example, may be further increased to R-6˜7/inch without releasing harmful blowing agents and increasing the cost per R value.

Another embodiment of the invention, provides the know-how to specifically modify material formulation and the design of die configuration in a continuous extrusion process in order to accomplish enhancement in insulation value through controlling pore morphology during a dynamic foaming process. While polystyrene (PS) foam extrusion was used as a model insulation system, all the disclosed arts of controlling pore morphology and orientation in the actual process of foaming may be readily modified for, and applicable to, many other similar insulation manufacturing processes desiring the same enhancement outcomes.

For thermal insulation products, pore morphology control, including the pore size, may be used to specifically increase the R/inch value along a heat flow direction. In certain embodiments, the desired morphology is to have an oblate pore structure with the shortest axis aligned in the direction of temperature gradient in application. In order to realize such favorable pore morphology and orientation during rapid foaming, we engineered, for example, the following three schemes to control the foam expansion after the polymer melt is extruded out of die opening:
(a) facilitating the homogeneous nucleation, in response to a sudden pressure drop after melt leaving the die, in order to generate numerous gas nuclei of sufficiently small sizes so that their subsequent growth may be manipulated in three separate directions;
(b) modifying die configuration in order to control the foam expansion in up-and-down direction (i.e. the direction normal to the surface of insulation board in production) of which the expansion is considerably depressed in comparison to the two other directions (the machine direction and its lateral counterpart in the same plane of the board surface); and
(c) generating additional tension stresses through internal disparity of expansion rates directionally and an external force field exerted by a post treatment system to further promote bubble growths in the two favorable directions (machine and in-plane lateral directions).

Another embodiment of the invention, provides a new generation of thermal insulation material produced by a polymer foaming process comprising and made from any, or a combination of, the following features:
(a) generating homogeneously smaller gas nuclei or domains by a homogeneous nucleation or spinodal decomposition, using primarily CO₂, or a similar inert gas, as a foaming agent such that the gas bubbles' geometry and orientation may be manipulated during their growth through controlled gas expansion,
(b) growing asymmetrical (oblate or prolate) pore morphology,
(c) orienting asymmetrical (oblate or prolate) pores with their shortest axis along the insulation application (i.e. the temperature gradient) direction.

Another embodiment of the invention, provides an article comprising the new generation of thermal insulation material produced by the polymer foaming process of the present invention, wherein the prescribed pore geometry (i.e. oblate, or prolate) and orientation (shortest axis is aligned in the direction normal to insulation board surface) are created by a die configuration design that reduces polymer melt swelling and gas expansion in the direction normal to the insulation board surface.

Another embodiment of the invention, provides an article comprising the new generation of thermal insulation material produced by the polymer foaming process of the present invention utilizing a die configuration having parallel slits of which the aspect ratio (width to length ratio) is used to control the polymer melt swelling and subsequent gas expansion ratio.

Another embodiment of the invention, provides an article comprising the new generation of thermal insulation material produced by the polymer foaming process of the present invention utilizing a die housing is attached for applying external compression (in vertical direction) and tension (in lateral direction) to further increase the expansion ratio in the lateral direction and consequently, the thermal insulation value in normal direction.

Another embodiment of the invention, provides an article comprising the new generation of thermal insulation material produced by, for example, the polymer foaming process of the present invention, the utilization of the extruder die of the present invention, or methods using the same, wherein an internal tension field is created and maintained by the addition of a compatible elastomer (for example, but not limited to, adding SEBS into polystyrene) to withstand a higher pressure drop at the extruder die exit and, thereby, enhance creation of more gas nuclei by homogenous nucleation under reduced pressure, or tension.

Another embodiment of the invention, provides an article comprising the new generation of thermal insulation material produced by, for example, the polymer foaming process of the present invention, the utilization of the extruder die of the present invention, or methods using the same, wherein the insulation material is created by a foaming process embedded within a polymer extrusion, or injection molding process.

Another embodiment of the invention, provides an article comprising the new generation of thermal insulation material produced by, for example, the polymer foaming process of the present invention, the utilization of the extruder die of the present invention, or methods using the same, wherein the polymer material is polystyrene, polyurethanes, polyethylene, polypropylene, polyethylene terephthalate that may be foamed to a low density, or the polymer material is a blend of polymers thereof.

In certain embodiments, procedures of the present invention may lead to the formation of anisotropically shaped bubbles orientated in the desired direction during foaming and thus, for example, enhance the R/inch value in the application direction of an insulation foam product.

Another embodiment of the invention, provides an extrusion die assembly comprising:
a) a body member, a pair of spaced lip members mounted on said body member each having a lip which together define an extrusion die orifice slot therebetween, where the slot has a length and width and the length is substantially larger than the width, and
b) a plurality of parallel dividers extending across the width of the slot defining a plurality of adjacent rectangular slit openings wherein each of the openings has a longest length extended transverse to the length of the slot.

Another embodiment of the invention, provides a foam extrusion die comprising a series of substantially uniform rectangular orifices aligned within a plane.

Another embodiment of the invention, provides a foam extrusion slot die comprising a plurality of parallel dividers extending transversely across the slot, wherein the plurality of dividers define a plurality of adjacent rectangular slit openings each having a length extending perpendicularly across the lateral length of the slot die.

Another embodiment of the invention, provides an extruder die for producing a foamed polymer sheet, comprising: i) an extruder attachment portion proximate the proximal end of the extruder die, for attaching to an extruder; ii) an elongated orifice, proximate the distal end of the extruder die, wherein the elongated orifice is partitioned by a plurality of parallel dividers defining a plurality of adjacent rectangular slit openings extending transversally across the length of the elongated orifice; and iii) an optional tapering portion connecting the extruder attachment portion and the elongated orifice.

Another embodiment of the invention, provides a foam extrusion die comprising: i) a body member having an inlet for receiving extrudate and a slot orifice for expelling extrudate, wherein the slot has a length and width and the length is substantially larger than the width; ii) a plurality of parallel dividers extending across the width of the slot defining a plurality of adjacent rectangular slit openings wherein each of the openings has a longest length extended transverse to the length of the slot, and iii) an optional tapering portion connecting the body member.

Another embodiment of the invention, provides an extruder slot die for producing a foamed polymer sheet, comprising: i) an extruder attachment portion proximate the proximal end of the die, for attaching to an extruder; ii) a plurality of parallel dividers, proximate the distal end of the die, defining a plurality of adjacent rectangular slit openings extending transversally across the length of the die; and iii) an optional tapering body portion between the proximal and distal ends of the die.

Another embodiment of the invention, provides an extruder die for producing a foamed polymer sheet, comprising: i) an extruder attachment portion proximate the proximal end of the die, for attaching to an extruder; and ii) a plurality of parallel dividers positioned proximate the distal end of the die, defining a plurality of slit openings each having a vertical height greater than a lateral width.

Another embodiment of the invention, provides a method of producing a polymer sheet having an asymmetrical pore morphology, comprising extruding polymer material through any of the extruder dies described herein.

Another embodiment of the invention, provides a method of producing a polymer sheet having an asymmetrical pore morphology, comprising: extruding polymer material through an extruder die opening having an elongated output orifice partitioned by a plurality of parallel dividers defining a plurality of adjacent slit openings extending transversally across the length of the elongated output orifice.

Another embodiment of the invention, provides a method for manufacturing an article comprising a polymer material system with at least 95% porosity comprising greater than 10% asymmetrical pores, comprising: extruding polymer material through an extruder die opening having an output orifice partitioned by a plurality of parallel dividers defining a plurality of adjacent slit openings each having a vertical height greater than a lateral width.

Another embodiment of the invention, provides an article of manufacture having an asymmetrical pore morphology produced by any one of the methods described herein.

Another embodiment of the invention, provides an article of manufacture, comprising a polymer material system with at least about 90% porosity and having greater than about 10% asymmetrical pores. For example, the asymmetrical pores may have a disc-shape pore morphology. In certain embodiments, the asymmetrical pore morphology is expanded in both lateral and machine directions while suppressed in vertical direction. In certain embodiments, the article of manufacture may comprise nanopores having a pore size no greater than 1500 nanometers in its shortest axis, for example, greater than 50% of the nanopores have a pore size no greater than 1500 nanometers in its shortest axis. In certain embodiments, the article of manufacture may comprise greater than 25% asymmetrical pores.

In certain embodiments, the article of manufacture may be an expanded polystyrene insulation panel having a thickness between 0.5 inches to 8 inches, a width between 1 foot to 10 feet and a length greater than the width. For example, in certain embodiments, the expanded polystyrene insulation panel comprises nanopores having a pore size no greater than 1500 nanometers in its shortest axis.

### BRIEF DESCRIPTION OF THE DRAWINGS

FIG. 1. Illustrates pore alignment in-series (a) or in-parallel (b) relative to the application direction.

FIG. 2. Illustrates (a) an extruder assembly with an exiting extrudate sheet, and (b) disc-shaped pores in an extrudate sheet (insulation material).

FIG. 3. Illustrates (a) a cross-sectional view of an rectangular extruder T-die extruding a polymer melt, (b) a cross-sectional view of an rectangular extruder T-die extruding a polymer melt, and (c) a front view of an rectangular extruder T-die having a slot output orifice.

FIG. 4. Illustrates (a) a front view of a portion of a rectangular T-Die having a series of parallel dividers, and (b) a transparent front view of a portion of a rectangular T-Die having a series of parallel dividers.

FIG. 5. SEM pictures of the cell structure along two different directions of a foam sample with sufficient numbers of prolate pores and high porosity.

FIG. 6. Factory produced foam insulation sample showing more expansion in lateral direction (x) than in machine direction (y).

FIG. 7. Factory produced foam insulation sample also showing more vertical expansion (z) than in machine direction (y).

FIG. 8. Factory produced foam insulation sample showing similar expansion ratio in both lateral (x) and vertical directions (z).

FIG. 9. Illustrates a perspective view of an extruder die.

FIG. 10. Illustrates an expanded view of the partitioned orifice of an extruder die.

FIG. 11. Illustrates a top view of an extruder die.

FIG. 12. Illustrates a front view of an extruder die.

FIG. 13. Illustrates a side view of an extruder die.

### DETAILED DESCRIPTION OF THE INVENTION

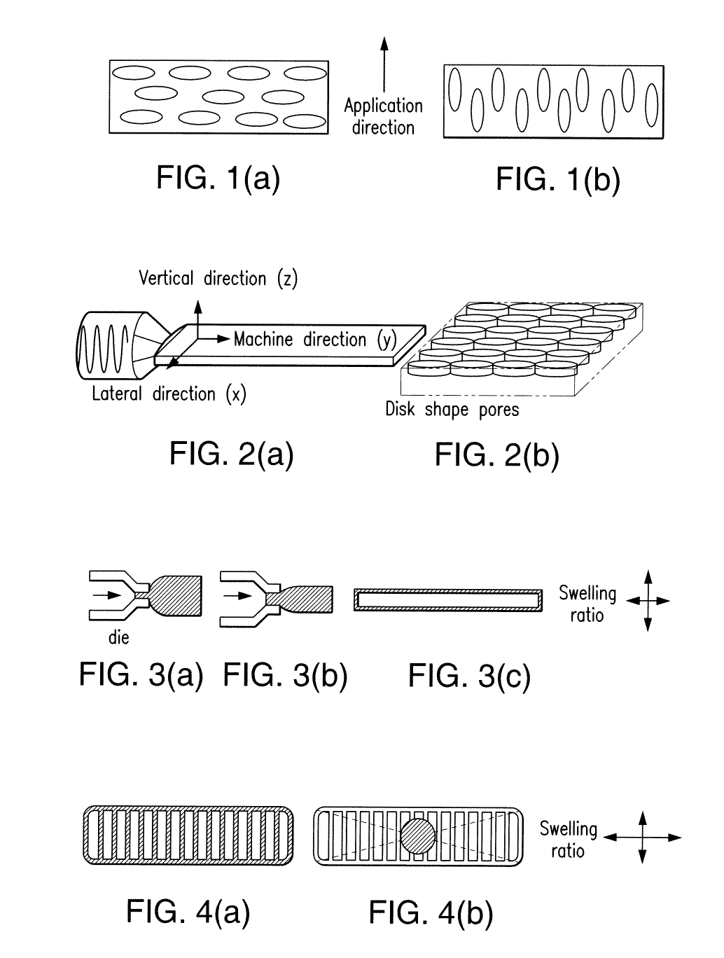

As early as a half century ago, thermal conductivity of a composite material could be modeled based on component's morphology and orientation (Reference 4). Foam is a composite of solid and air bubbles. Similar to electrical conductivity, the thermal conductivity of certain composites have an upper limit with both components' thermal conductions aligned in parallel and a lower bound when they are aligned in series (Reference 5). Further modeling calculations (References 2, 3, 6, and 7) manifested that aligning ellipsoidal inclusions along their longest axis may effectively increase thermal resistance in a vertical direction at the expense of resistance in the direction parallel to the long axis. An example of enhancing insulation value in the direction of application (i.e. temperature gradient direction), is illustrated in FIG. 1, wherein spheroids (representing pores) are aligned in-series (a), or in-parallel (b) with the application direction. The material having the pores aligned in-series has a lower thermal conductivity (higher insulation value) than the material having the pores aligned in-parallel with the application.

Moreover, theoretical calculation also indicated that the alignment of oblate (disk-shaped) pores is even more effective in insulation enhancement than needle-shaped pores. (Reference 8) FIG. 2(a) illustrates, for example, an extruder assembly with an extrudate sheet material, such as an thermal insulation foam boards, exiting an extruder orifice. In certain embodiments, to maximize such R value enhancement through the creation and orientation of anisotropic pores in thermal insulation foam boards, a foam extrusion process may be engineered to favor the gas bubble expansion in two directions, the machine (extrusion) direction and lateral direction, respectively, as illustrated in FIG. 2(b). Promoting expansions, in both lateral and machine directions, while depressing the vertical expansion, as illustrated in FIG. 2(b), may be suitable for preparing materials having an oriented pore geometry in favor of the insulation value in vertical direction.

In certain embodiments, creating oriented oblate pores in extrusion may include utilizing certain procedures outlined above, such as—inducing the homogeneous nucleation, depressing the die swelling ratio in the vertical direction (z), and facilitating bubble growth in both machine and lateral directions (y, x) vie a created tension stress field.

Nucleating Small Gas Embryos.

Conventional insulation foam extrusion requires the addition of nucleating agent to facilitate creation of the initial small gas bubbles. Gas bubbles created by heterogeneous nucleation are generally several orders of magnitude bigger than gas nuclei obtainable from a homogeneous nucleation, and thus, have much less latitude for controlling bubble growth. Another embodiment of the present invention, utilizes material additive technology that may induce and promote homogeneous nucleation, which may be suitable for creating gas nuclei in the range of tens of nanometers. The critical nucleation size of the gas nuclei may be estimated from the following equations:

$$\begin{matrix}{P}_{i n} - {P}_{out} = Δ P = \frac{2 σ}{r} , & Equation ( 1 ) \\ Δ {G}_{a} = \frac{4 π {r}^{2} σ}{3} , \\ or , & Equation ( 2 ) \\ Δ {G}_{a} = \frac{16 π {σ}^{3}}{3 {( Δ P )}^{2}} & Equation ( 3 )\end{matrix}$$

where, ΔP is pressure quench, σ is surface tension, Gₐ is the Gibbs free energy of activation.

An aspect of the invention relates to a blended SEBS (Styrene-Ethylene-Butadiene-Styrene copolymer) elastomer and surface-modified clay as an additive to lower the interfacial tension, σ, and successfully achieved the homogeneous nucleation both in pressure vessel foaming as well as in production extrusion experiments. Such an induced nucleation process could guarantee that gas nuclei be created only after the pressure quench at die exit so that their subsequent expansion into bubbles may be adequately engineered through designing die configuration and controlled by a post-treatment system thereafter.

Die Swelling Adjustment.

Die swelling may occur when a viscous polymer melt, coming out of a die, relaxes from the strong shearing force imposed by the boundary walls within a die. Generally, the higher the shearing rates in a die, the bigger the swelling after exiting. Extruding a foam insulation board normally requires a T-shaped slit die with a rectangular opening. The rectangle is usually much wider in the lateral direction than vertically, and thus, may induce substantially bigger vertical than lateral swelling, reflecting the differences in shearing rates within the die. FIG. 3(a) illustrates, for example, a cross-sectional view along the vertical-machine plane of an rectangular extruder T-die having a narrow output orifice in the vertical direction extruding a polymer melt, while FIG. 3(b) illustrates, for example, a cross-sectional view along the vertical-machine plane of an rectangular extruder T-die having a wide output orifice in the vertical direction extruding a polymer melt. Not wanting to be held to any particular theory, at equal melt throughput rates, the small die opening of FIG. 3(a) may lead to much bigger polymer swelling after die exit than a larger die opening in FIG. 3(b). FIG. 3(c) illustrates, for example, a front view along the vertical-machine plane of an rectangular extruder T-die having a slot output orifice, which results in the vertical swelling at die exit being substantially bigger than the lateral one because of smaller opening. The internal tension forces created by a sudden swelling may favor bubble nucleation (bigger pressure differences in equation 1) and the subsequent growth along the same direction.

An aspect of the invention relates to a new die design containing a series parallel rectangular slits, each one with a shape much narrower laterally than vertically, such that the extruded polymer melt swells more appreciably in lateral direction than vertically. FIG. 4(a) illustrates, for example, a front view of a portion of a rectangular T-Die having a series of parallel dividers defining a series of adjacent rectangular slit openings of narrower lateral width, and FIG. 4(b) illustrates, for example, a transparent front view of a portion of a rectangular T-Die having a series of parallel dividers defining a series of adjacent rectangular slit openings of narrower lateral width. The adjacent rectangular slit openings illustrated in FIGS. 4(a) and (b), having a narrower lateral width may be suitable for creating a swelling ratio much more appreciable in the lateral than the vertical direction. The lateral swelling and the melt's unobstructed expansion in the machine direction may create a velocity field more appreciable in those directions, and thus, may facilitate bubble expansions in the two respective directions than the vertical expansion.

A further aspect of the invention provides a die design, in comparison to traditional T-die, that offers additional versatility in pressure control as its total number and the width of the parallel slits may be independently adjusted to fine tune the desired die pressure drop in any given throughput rate. (In contrast, the pressure drop out of a T-die may only passively be determined by one die width required for producing a fixed board thickness at a given throughput range of production extruder.) Reducing polymer swell in vertical direction may make the board thickness control considerably easier. In certain embodiments, the die design of the present invention may, in view of the proposed post-die forming mechanism described below, maintain the least dimension change (i.e. volume expansion) along the vertical direction, which may advantageously lead to the easiest and the most precise control of insulation board thickness by a foam extrusion process.

Post-Die Forming by Tension Forces.

An aspect of the invention utilizes, for example, a homogeneous nucleation approach to minimize, suppress, or eliminate, polymer melt expansion until after exiting through the die opening. Not wanting to be held to any particular theory, the extruder die design shown in FIG. 4, for example, by having aligned rectangular slits of a large height to width ratio, may further assure that the die swelling and the subsequent volume expansion both occur predominantly in the lateral and machine directions. The exit velocities of the extruded melt may, for the same reason, also have a large disparity in the three directions. The higher expansion rates in lateral and machine directions may be utilized for creating internal tension force fields (augmented by the addition of melt-strengthening, elastomeric SEBS), to further promote homogeneous nucleation and bubble expansion in those directions.

An aspect of the invention relates to the creation of one or more of a force field, a tension force along lateral and machine directions, and a compression force in vertical direction, to further maneuver expansion ratio after die swelling. The tension forces may be generated either internally through sudden velocity increases in die swelling, or externally applied through a post-die treatment system. A structural attachment of die, either in the form of die-lips or die-housing, may exert compression forces from top and down. Furthermore, tensional pulls in both lateral and machine directions may also be externally applied in order to further expand foam in the desired directions.

At present, certain post-die treatment systems have been used, for example, to correct board thickness and surface unevenness. For example, a multi-roller assembly with top-down compressing power may be sufficient for these two tasks. In certain embodiments, this system has been modified so that the roller speed may be adjusted to be faster than the board's machine speed and, consequently, the rollers' frictional forces to the board may generate a pulling in the machine direction. In certain embodiments, when such a roller system is positioned near the die, the pulling force may create a tension force in favor of expansion in the machine direction. In certain embodiments, the elastomeric component added for improving melt strength may be capable of sustaining a bigger tension force without breaking up the foam board. Additionally a tension force field in the lateral direction may be provided, for example, by drawing a vacuum from the back of the die-housing. In certain embodiments, the die-housing may be designed to capture and contain the foam expansion so that the gas escaping from the back is properly sealed off.

An aspect of the invention relates to thermal insulation or superinsulation articles having a desired porosity, reduced pore size and cost-effective methods for manufacturing such articles. In one aspect of the present invention, the article may comprise a material system with at least about 20% porosity, for example, 30%, 40%, 50%, 60%, 70%, 80%, preferably at least about 90% porosity, for example, 95%, 96%, 97%, 98%, and 99%. In a further aspect of the invention, an article may comprise greater than about 25%, 50%, 75%, and 90% of nanopores having a pore size no greater than about 1500 nanometers, for example, 1250 nanometers, 1000 nanometers, preferably no greater than about 900 nanometers, 800 nanometers, 750, nanometers, 700 nanometers, 650 nanometers, 600 nanometers, and 550 nanometers, in its shortest axis.

The articles of the present invention, in addition to porosity and a reduced pore size, may also comprise asymmetrical nanopores. In one aspect of the present invention, the articles may comprise greater than about 10% asymmetrical pores, for example, 25%, 40%, and 50%, preferably greater than about 75%, 80%, 90%, and 95%. One aspect of the present invention is an article comprising greater than about 25%, for example, 35%, 50%, preferably greater than about 75%, for example, 80%, 85%, 90%, and 95% oblate or substantially oblate nanopores. Another aspect of the present invention is an article comprising greater than about 25%, for example, 35%, 50%, preferably greater than about 75%, for example, 80%, 85%, 90%, and 95% prolate or substantially prolate nanopores. Yet, another aspect of the present invention may be an article comprising nanopores having an asymmetry unlike oblate or prolate but maintaining a controlled pore dimension in a preferred application directions (e.g, the thermal gradient direction). Furthermore, an article of the present invention may comprise a combination of oblate or substantially oblate, prolate or substantially prolate, and other asymmetrical nanopores.

The articles of the present invention may also comprise nanopores oriented in a preferred direction. In one aspect of the present invention, one or more nanopores are oriented normal to the application direction (i.e. when reference is made herein the orientation of the nanopore is referring to the longest axis of the pore. Therefore, the longest axis of the pore, and the pore orientation, is normal to the application direction. Conversely, the shortest axis is aligned with the application direction.) or substantially normal to the application direction. In another aspect of the present invention, one or more nanopores are oriented normal to the thermal gradient direction or substantially oriented normal to the thermal gradient direction. In another aspect of the present invention, one or more nanopores are oriented along the machine direction (i.e. the shortest axis normal to the machine direction) or substantially along the machine direction. Yet, in one aspect of the present invention, an article may comprise greater than about 25%, for example, 35%, 45%, 55%, preferably greater than 75%, for example 80%, 85%, 90%, and 95%, of nanopores oriented normal to the thermal gradient direction or substantially oriented normal to the thermal gradient direction.

The articles of the present invention may also comprise a secondary nanostructure. Furthermore, the articles of the present invention may comprise a tertiary and/or quaternary nanostructure. In one aspect of the present invention, an article may comprise greater than about 25%, for example, 35%, 45% and 50%, preferably greater than about 75%, 80%, 85%, 90%, and 95%, of nanopores with secondary, tertiary and/or quaternary structure. One aspect of the present invention is an article comprising a secondary nanostructure comprising a surfactant or alternatively any known surface-tension lowering agents or functionally equivalent thereof. A further aspect of the present invention may be an article comprising greater than about 25%, for example, 35%, 45%, and 50%, preferably greater than about 75%, 80%, 85%, 90%, and 95%, of nanopores with a surfactant or known equivalent thereof. Another aspect of the present invention may be a secondary nanostructure comprising an intertwining fractal structure or alternatively a substantially intertwining fractal structure. A further aspect of the present invention may be an article comprising greater than about 25%, for example, 35%, 45%, and 50%, preferably greater than about 75%, 80%, 85%, 90%, and 95%, of nanopores with an intertwining fractal structure and/or substantially intertwining fractal structure. Yet, another aspect of the present invention may be an article comprising greater than 5%, for example, 10%, 20%, 50%, nanopores having one or more secondary, tertiary, and/or quaternary structures.

Furthermore, the articles of the present invention may have a thermal insulation value greater than about 6 R/inch, for example 6.5 R/inch, and 7 R/inch, preferably greater than about 7.5 R/inch, for example 8 R/inch, 8.5 R/inch, 9 R/inch, 9.5 R/inch, and 10 R/inch. In another aspect of this invention, the articles of the present invention may have a thermal conductivity value less than about 30 mW/M° K, for example 25 mW/M° K, and 23 mW/M° K, preferably less than about 22 mW/M° K, for example 21 mW/M° K, 20 mW/M° K, and 15 mW/M° K.

The articles of the present invention may be manufactured by creating or generating or substantially creating or generating one or more gas embryos. In one aspect of the present invention, the gas embryos or the known equivalent thereof are created by homogenous nucleation or any other known means of nucleation without preferential nucleation sites. In one aspect of the present invention, an article comprises greater than about 25%, for example, 35%, 50%, preferably greater than about 75%, 80%, 85%, 90%, and 95%, of gas embryos created or generated by such means or the equivalent thereof. In another aspect of the present invention, the gas embryos are created or generated by spinodal decomposition or any known means creating a phase separation throughout the material and not just at the nucleation sites. In one aspect of the present invention, an article comprises greater than about 25%, for example, 35%, 50%, preferably greater than about 75%, 80%, 85%, 90%, and 95%, of gas embryos created or generated by spinodal decomposition or the equivalent means thereof. Yet, in another aspect of the present invention, a combination of such methods for creating or generating gas embryos may be used.

In a further aspect of the present invention, an article may comprise one or more gas embryos having a size not greater than about 1000 nanometers, for example, 900 nanometers, 800 nanometers, 700 nanometers, 600 nanometers, 550 nanometers, preferably not greater than 500 nanometers, for example, 450 nanometers, 400 nanometers, 350 nanometers, 300 nanometers, 250 nanometers, 200 nanometers, 150 nanometers, 100 nanometers, and 50 nanometers.

In another aspect of the present invention, the gas embryos may be expanded by or substantially expanded by using a foaming process, including any known equivalents means thereof. In one aspect of the present invention, an article comprises greater than about 25%, for example, 35%, 50%, preferably greater than about 75%, for example 80%, 85%, 90%, and 95%, of gas embryos expanded by, or substantially expanded by, batch foaming. In another aspect of the present invention, the gas embryos are expanded by or substantially expanded by a continuous foam extrusion process or an equivalent means thereof. In one aspect of the present invention, an article comprises greater than about 25%, for example, 35%, 50%, preferably greater than about 75%, for example 80%, 85%, 90%, and 95%, of gas embryos expanded by, or substantially expanded by, a continuous foam extrusion process. Yet, in another aspect of the present invention, the gas embryos are expanded by, or substantially expanded by, a combination of such means.

In yet a further aspect of the present invention, the pore size of greater than about 25%, for example, 35%, 50%, preferably greater than about 75%, for example, 80%, 85%, 90%, and 95% gas embryos is controlled by, or substantially controlled by, one or more restriction methods or equivalent restriction means thereof, including any known size controlling methods, affecting one or more of pore morphology, pore orientation, and/or secondary nanostructure aspects of the nanopores.

In a further aspect of the present invention, the embedded inert gas may be exchanged by air over time. In one aspect of the present invention, greater than 5% of the inert gas, for example, 10%, 25%, and 40%, preferably greater than 50%, for example, 60%, 70%, 80%, 90% and 95%, may be exchanged by air over time. In another aspect of the present invention, embedded inert gas may be exchanged by air over time, such as greater than 10 days, for example 20 days, 30 days, and 45 days, preferably greater than 60 days, for example, 90 days, 120 days, 180 days, and 360 days. Accordingly, inert gas may include a mixture of the blowing gas (e.g., CO₂) and air, for example, at about 10:90, about 50:50, and about 90:10, percent blowing gas to percent air. Furthermore, inert gas may also include 100 percent blowing gas or 100 percent air.

The term “third generation thermal insulation” is understood to refer to insulation material composed of air pockets with composition and morphology specially designed to lower the embedded air's thermal conductivity below its ordinary value (i.e. <23 mW/M ° K), resulting in a super insulation of insulation value higher than at least R-7/inch.

An aspect of the invention relates to four important components, which collectively could realize a cost-effective production of the third generation of insulation with thermal conductivity much lower than the second generation products:
(a) Generating homogeneously smaller gas embryos or domains by a homogeneous nucleation, or spinodal decomposition process, using CO2 entrapped as either a blowing agent or a co-solvent within a polymer system,
(b) Growing asymmetrical (oblate or prolate) pore morphology,
(c) Orienting asymmetrical (oblate or prolate) pores in a preferred direction,
(d) Creating the secondary nanopore structure within air pores.

Another aspect of the invention relates to methods of preparing super insulation having nanopore structures achieved by, for example, utilizing the expansion power of a high-pressure gas embedded in the form of either a solute, or a co-solvent, to create the high porosity required by a super thermal insulation. Furthermore, the gas embryos or domains may be created by a homogeneous nucleation, or spinodal decomposition, process in an effort to control the bubbles' growth from their initial births. An aspect of the present invention incorporates, for example, three additional innovations (b, c, and d listed above) in addition to pore size reduction which may all be capable of further increasing the insulation value of a porous substrate. These three options could each individually be utilized to improve insulation value of a current foam product. Collectively, they could be engineered, along with using pore size reduction, to accomplish the required technology jump to that of a super insulation through incremental technology improvements.

Another aspect of the invention relates to methods utilizing the directional characteristics of a transport property such as the thermal conductivity in the preparation of thermal insulation materials. For a composite of polymer and air pores, the spatial geometry and orientation of the pores could be utilized to improve the insulation value along the heat flow direction (i.e. the direction of the temperature gradient, or, the application direction). Analogous to the spatial arrangements of resistor-in-parallel (highest conductivity), and resistor-in-series (lowest conductivity), we may utilize the orientations of spheroid pores in parallel (long axis in parallel to the heat flow direction), or, in series (long axis normal to the heat flow direction) to optimize insulation value. Not wanting to be held to any particular theory, one possible theory has indicated that the increase of heat resistance in one direction (application direction) would be at the expenses of the resistances of the two other directions, which may be irrelevant to insulation performances.

Another aspect of the invention relates to the ability of using pore geometry and orientation to further complement the effect by pore size reduction, which may, for example, provide substantial leverages of making a super thermal insulation. Not wanting to be held to any particular theory, the difficult task of pore size reduction (to below the mean free path of air) could be limited to just one direction (the application direction), instead of all three directions. In other words, for spheroids oriented in series with the application direction, only their shortest axes may need to be controlled below the threshold value. Relaxations of size controls in the other two irrelevant directions may allow a much larger volume for each pore, and therefore, much less pore density be created by foaming Second, the effects of geometry and orientation could help reduce thermal conductivity on top of what already achievable by pore size reduction. Moreover, in certain embodiments, unlike pore size reduction, the aspect ratio of spheroids, for example, has no threshold value to pass. In certain embodiments, the effects of orientation appear once the shape is asymmetrical, and increase with increasing aspect ratios; resulting in the possible stepwise increases of, in conjunction to effect of pore size reduction, thermal insulation value from current standard to that of a new generation.

An aspect of the invention relates to third generation thermal insulation material comprising and made from any, or a combination of, the following features:
(a) generating homogeneously smaller gas embryos or domains by a homogeneous nucleation or spinodal decomposition process, using primarily CO₂, or a similar inert gas, entrapped as either a blowing agent or a co-solvent in a polymer system,
(b) growing asymmetrical (oblate or prolate) pore morphology,
(c) orienting asymmetrical (oblate or prolate) pores with their short axis along the insulation application (i.e. the temperature gradient) direction,
(d) creating the secondary nanopore structure within air pores, which may be formed by, but not limited to, the surfactant structure incorporated at the pore surface, or an intertwining fractal structure within each pore.

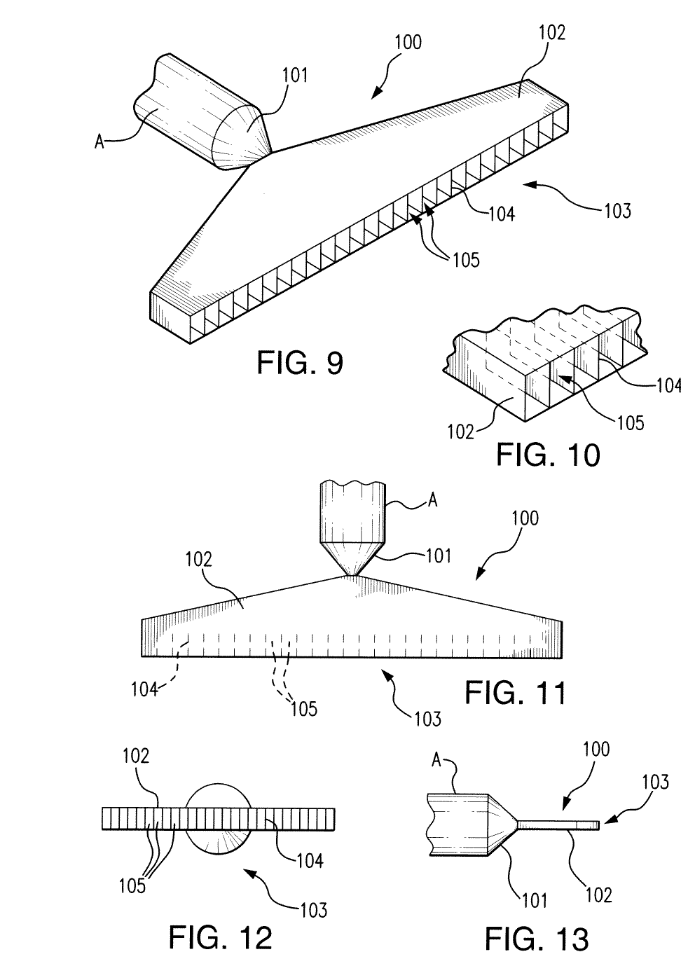

A perspective view of an extruder die (100) attached to an extruder outlet (A) is illustrated, for example, in FIG. 9. The extruder attachment portion (102) of the extruder die shown in FIG. 9, illustrated with the optional tapering portion, is attached to the extruder outlet via a tapering adapter (101). The tapering adapter (101) may be permanently fixed to the extruder die (100) or detachable, or may be permanently fixed to the extruder outlet (A) or detachable. The elongated output orifice (103), sometimes referred to as a slot), located at the distal portion of the extruder attachment portion (102), is divided by a plurality of parallel dividers (104), which define a plurality of adjacent rectangular slit openings (105) extending transversally across the length of the elongated output orifice. An expanded view of a partitioned output orifice (103) of an extruder die (100) is illustrated, for example, in FIG. 10. A top view of an extruder die (100) is illustrated, for example, in FIG. 11. A front view of an extruder die (100) is illustrated, for example, in FIG. 12. A side view of an extruder die (100) is illustrated, for example, in FIG. 13.

In certain embodiments, the plurality of parallel dividers (104) may extend from the elongated orifice (103) towards the proximal end of the extruder die (100), for example, the extension of the parallel dividers towards the proximal end of the extruder die may be between about 5% to 100% the length of the extruder attachment portion in the machine direction, such as 10%, 20%, 30%, 40%, 50%, 75%, 90%, or 100% the length of the extruder attachment portion in the machine direction. In certain embodiments, the transversal extension of the plurality of parallel dividers (104) and the plurality of adjacent rectangular slit openings (105) across the length of the elongated output orifice may be 1-179° relative to the length of the elongated output orifice, for example, the transversal extension of the plurality of parallel dividers (104) and the plurality of adjacent rectangular slit openings across the length of the elongated output orifice may be 5°, 15°, 30°, 45°, 60°, 75°, 90°, 105°, 120°, 135°, 150°, 165°, or 175° relative to the length of the elongated output orifice. In certain embodiments, the plurality of adjacent rectangular slit openings (105) the vertical height to lateral width ratio of the slit openings is greater than 1.2:1, for example, the vertical height to lateral width ratio of the slit openings is in the range of between 1.2:1 to 100:1, such as in the range of between 1.5:1 to 100:1, between 2:1 to 100:1, between 3:1 to 100:1, between 5:1 to 100:1, between 10:1 to 100:1, between 15:1 to 100:1, between 20:1 to 90:1, between 30:1 to 90:1, between 40:1 to 90:1, between 50:1 to 90:1, or between 75:1 to 100:1. In certain embodiments, the width to length ratio of the plurality of adjacent slit openings (105) is used to control the polymer melt swelling and subsequent gas expansion ratio.

In certain embodiments, the elongated output orifice (103) has a lateral width in the range of between 0.5 to 8 feet, for example, a lateral width in the range of between 2 to 6 feet, such as between 3 to 5 feet, between 3 to 3.5 feet, or has a lateral width of 4 feet. In certain embodiments, the elongated output orifice (103) has a vertical height in the range of between ⅕ to 1/10 of the required thickness of the produced polymer sheet after expansion. In certain embodiments, the elongated output orifice (103) has a vertical height in the range of between 0.05 to 2 inches, for example, a vertical height in the range of between 0.05 to 1 inches, such as between 0.05 to 0.8 inches, between 0.1 to 0.5 inches, or between 0.1 to 0.4 inches. In certain embodiments, the elongated output orifice (103) has a lateral width to vertical height ratio in the range of between 100:1 to 3,000:1, for example, a lateral width to vertical height ratio of 200:1 or more, such as 240:1 or more, 300:1 or more, 480:1 or more, or 960:1 or more.

In certain embodiments, the extruder die (100) may be a heated extruder die or a chilled extruder die.

In certain embodiments, the elongated output orifice (103) comprises one or more blocks of a plurality of parallel dividers, wherein the one or more blocks have a lateral width less than the lateral width of the output orifice of the extruder die, for example, two, three, four, five, or six or more blocks having a lateral width less than the lateral width of the output orifice of the extruder die.

In certain embodiments, the extruder attachment portion (102) may include an optional tapering portion, which may taper expansively in the lateral direction, the machine direction, the vertical direction, or combinations thereof. For example, a tapering portion of the extruder attachment portion (102) may taper expansively in the lateral direction and the machine direction, or may taper expansively in the lateral direction, the machine direction, and the vertical direction.

FIGS. 9-12 depict an extruder die having the optional tapering portion, but it is also envisaged in a further embodiment that the extruder die may be more or less uniform in dimension (for example rectangular with no tapering section) and attach to (or fit into) an extruder head or an extruder adapter. For example, the die could have an inlet for receiving the extrudate and an orifice for expelling the extrudate wherein the inlet and the outlet are substantially the same dimension. FIGS. 9-12 depict an extruder die having the parallel dividers (104) in a selected number with a selected spacing for illustration purposes, but are not meant to be limiting in size, dimension, or spacing.

### EXAMPLES

The first example shown below was from a previous work in pressure vessel foaming (see Example 1 in PCT/US2009/002693). It is shown here to provide the magnitude of improvement to be expected from pore orientation. The focus of this invention is to create such effects in a continuous foam extrusion process.

### Example 1

### Oriented Prolate Pores Reducing the Thermal K by 10-15%

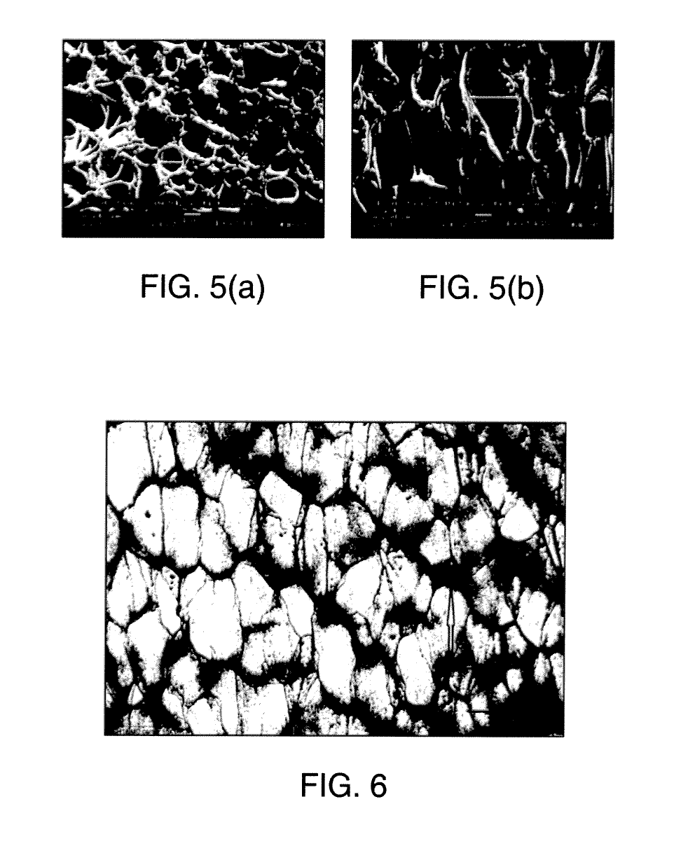

Pressurized vessel experiments produced foams with anisotropic pore structure. For example, FIG. 5 depicts the SEM pictures of the cell structure along two different directions of a foam sample with sufficient numbers of prolate pores and high porosity (97%), which demonstrated differences in thermal conductivity measured along two directions (long polar axis and shorter equator axes).

This particular sample was produced in a pressurized vessel with a sudden release of pressure by opening a valve at the top of the vessel. This setup provided a favorable direction of foam expansion (towards the top of the vessel), thereby, creating anisotropic expansion ratios of the foam (higher expansion ratio to the top than to the sides). The difference in expansion ratios led to prolate (needle like) cell structure shown by the SEM micrographs in FIG. 5. The sample density was 0.023 gram/cc. Thermal conductivities measured along two directions (long polar axis and the short equator axes) were 37 and 33 mW/M ° K, respectively. The 12% reduction in thermal conductivity agreed well with modeling results for the prolate geometry. According to the same modeling calculation, oblate pore structure may further lower the thermal conductivity to 26 mW/M ° K.

### Example 2

### Homogenous Nucleation of SEBS and Clay Foams

A series of foaming experiments were conducted in a pressure vessel to establish the conditions of foaming SEBS and PS blend prior to full-capacity foaming run at a production extruder. The pressure vessel experiments use a small amount of batch material and may be repeated many times in order to find the best conditions for CO₂ foaming. This has been the most efficient method of screening new materials and ingredients for pilot and/or full capacity foaming extrusion experiments. While sometimes the foaming results by a pressure vessel may not be as good as obtainable from a production machine (due to the limitations on foaming condition adjustments), they do provide adequate correlation to a real production run such that they may considerably simplify the task and reduce the wastes of running a new composite formulation in full-capacity production.

From several series of pressure vessel experiments of foaming SEBS-PS blend, the combination of material composition and foaming conditions using about 10% of SEBS-MA (Maleic anhydride modified SEBS) in the blend with PS was selected. The material batch foamed to very low density (˜97% porosity at 30 kg/m³ and with average pore size smaller than 100 μm). Since the low density and small pore size were achieved without the addition of any traditional nucleation agent (such as talc), the gas nuclei most likely occurred by a homogeneous nucleation process. Additionally, the PS and SEBS-MA batch with a small amount (0.3%) additive of modified clay (Closite 10A, Souther Clay Products Inc.) showed the smallest cell size at a very high porosity indicating the clay surface may facilitate a homogeneous nucleation process. This batch of blend material was further tested in foaming experiments conducted at factory production line. Samples obtained from pressure vessel foaming with a sequence of variations in material composition and foaming conditions, are summarized in Table 1 below:

TABLE 1

| | | | Polymer | | | | | |
|---|---|---|---|---|---|---|---|---|
| | Pressure Vessel | | Composition | | Additives | | | Cell Size |
| Run | Saturation | Foaming | PS | SEBS- | Additive | Composition | Density | Average |
| ID | Conditions | Conditions | 1600 | MA | Type | (w/w) | (kg/m³) | (μm) |
| 10-1 | 135° C./22 hr | 120° C./4 hr | 100% | 0% | None | 0.0% | 31.2 | 120 |
| | 120 Bar | 40 Bar/s | | | | | | |
| 9-1 | 135° C./22 hr | 120° C./4 hr | 91% | 9% | None | 0.0% | 42.3 | 81 |
| | 120 Bar | 40 Bar/s | | | | | | |
| 10-11 | 135° C./22 hr | 120° C. | 91.7% | 9% | Dynamar | 0.3% | 34.5 | 86 |
| | 120 Bar | 40 Bar/s | | | FX9613 | | | |
| 9-2 | 135° C./22 hr | 122° C./4 hr | 91.7% | 9% | Cloisite 10A | 0.3% | 31.7 | 66 |
| | 120 Bar | 120 Bar/s | | | | | | |
| 9-6 | 135° C./22 hr | 120° C./4 hr | 87% | 9% | Cloisite 10A | 2% | 31.9 | 93 |
| | 120 Bar | 40 Bar/s | | | Silvet 960-25-E | 2% | | |
| | | | | | (Al Flakes) | | | |

### Examples 3-5

### Pore Orientation in a Foam Extrusion Process

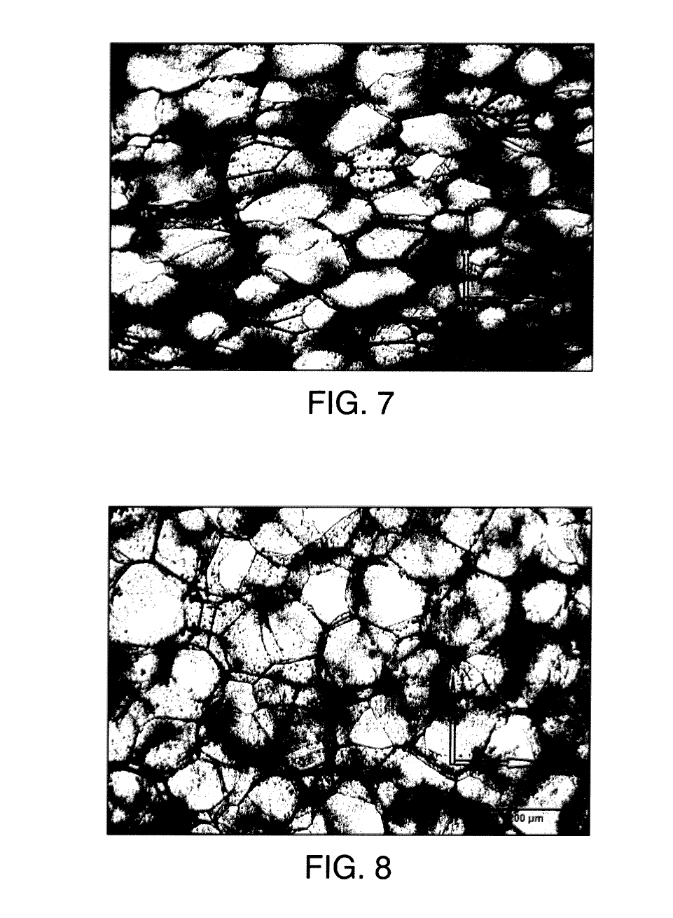

FIGS. 6, 7 and 8 depict three optical microscope pictures which demonstrated, for example, the feasibility of creating and orienting anisotropic pore structures in a real insulation foam production process. The three directions of interest are lateral (x), machine (y), and vertical (z) of which the x-y plane lies on the surface of the insulation board. For example, FIG. 6 illustrates a factory produced foam insulation sample that showed more expansion in lateral direction (x) than in machine direction (y); FIG. 7 illustrates a factory produced foam insulation sample also showed more vertical expansion (z) than in machine direction (y); and FIG. 8 illustrates a factory produced foam insulation sample showed similar expansion ratio in lateral (x) and vertical directions (z).

The full production line experiment was run with an extruder of 750 kg/hour speed and equipped with a traditional T-die which cannot produce the disk-like pore structure desired by this invention. However, the geometry and orientation of such produced insulation foam, for example, did agree with the analysis and conjecture of relating expansion ratio with the polymer swelling and the internal distribution of vector force fields.

The picture shown in FIG. 6 demonstrates, for example, considerable lateral expansion compared with the expansion in the extrusion (machine) direction. The T-die of this extrusion equipment did allow pre-die expansion in the lateral direction in order to produce board with sufficient width (>4 ft) required by the specification of building insulation product. Secondly, there was a post-treatment compressor to control the board thickness within specification (one inch), which, due to the friction to the surface of the board, impeded the expansion in the machine direction (y).

For the same reason, the vertical expansion, due to the considerable die swelling of polymer melt in this direction, had shown much higher expansion ratio in comparison to the machine direction expansion.

The picture shown in FIG. 8 demonstrates, for example, that the lateral and vertical expansion ratios are comparable to each other indicating that the swelling of polymer melt of a T-die are primarily in these two directions. In certain embodiments, the extruder die of the present invention, for example as shown in FIG. 4, the lateral expansion will be increased substantially bigger than vertical expansion to produce the disk-like pore morphology for enhancing thermal conductivity in the main application direction.

In the following, further embodiments are explained with the help of subsequent examples, starting at Example 6.

### Examples 6-102

### Example 6

A foam extrusion die comprising a series of substantially uniform rectangular orifices aligned within a plane.

### Example 7

A foam extrusion slot die comprising a plurality of parallel dividers extending transversely across the slot, wherein the plurality of dividers define a plurality of adjacent rectangular slit openings each having a length extending perpendicularly across the lateral length of the slot die.

### Example 8

An extruder die for producing a foamed polymer sheet, comprising:
i) an extruder attachment portion proximate the proximal end of the extruder die, for attaching to an extruder;
ii) an elongated orifice, proximate the distal end of the extruder die, wherein the elongated orifice is partitioned by a plurality of parallel dividers defining a plurality of adjacent rectangular slit openings extending transversally across the length of the elongated orifice; and
iii) an optional tapering portion connecting the extruder attachment portion and the elongated orifice.

### Example 9

A foam extrusion die comprising:
i) a body member having an inlet for receiving extrudate and a slot orifice for expelling extrudate, wherein the slot has a length and width and the length is substantially larger than the width;
ii) a plurality of parallel dividers extending across the width of the slot defining a plurality of adjacent rectangular slit openings wherein each of the openings has a longest length extended transverse to the length of the slot, and
iii) an optional tapering portion connecting the body member.

### Example 10

An extruder slot die for producing a foamed polymer sheet, comprising:
i) an extruder attachment portion proximate the proximal end of the die, for attaching to an extruder;
ii) a plurality of parallel dividers, proximate the distal end of the die, defining a plurality of adjacent rectangular slit openings extending transversally across the length of the die; and
iii) an optional tapering body portion between the proximal and distal ends of the die.

### Example 11

An extruder die for producing a foamed polymer sheet, comprising:
i) an extruder attachment portion proximate the proximal end of the die, for attaching to an extruder; and
ii) a plurality of parallel dividers positioned proximate the distal end of the die, defining a plurality of slit openings each having a vertical height greater than a lateral width.

### Example 12

The extruder die of any one of claims 6-11, wherein the longest length of the rectangular orifices extends transverse to the plane.

### Example 13

The extruder die of any one of claims 6-12, wherein the longest length of the rectangular orifices are adjacent.

### Example 14

The extruder die of any one of claims 6-13, wherein each of the rectangular orifices are oriented in the same direction.

### Example 15

The extruder die of any one of claims 6-14, wherein each of the rectangular orifices are substantially the same size.

### Example 16

The extruder die of any one of claims 6-15, wherein the vertical height to lateral width ratio of the slit openings is greater than 1.2:1.

### Example 17

The extruder die of any one of claims 6-16, wherein the vertical height to lateral width ratio of the slit openings is in the range of between 1.2:1 to 100:1.

### Example 18

The extruder die of any one of claims 6-17, wherein the slit openings are rectangular slit openings.

### Example 19

The extruder die of any one of claims 6-18, wherein the extruder die further comprises a tapering adapter.

### Example 20

The extruder die of any one of claims 6-19, wherein the tapering adapter couples an extruder outlet to the extruder attachment portion of the extruder die.

### Example 21

The extruder die of any one of claims 6-20, wherein the plurality of parallel dividers transversely extend from the output orifice towards the proximal end of the extruder die.

### Example 22

The extruder die of any one of claims 6-21, wherein the transversal extension of the parallel dividers is sufficient to form an asymmetrical pore morphology in the foamed polymer sheet.

### Example 23

The extruder die of claim 22, wherein the asymmetrical pore morphology is expanded in both lateral and machine directions while suppressed in vertical direction.

### Example 24

The extruder die of claim 22 or 23, wherein the asymmetrical pore morphology is a disc-shape pore morphology.

### Example 25

The extruder die of any one of claims 6-24, wherein the extension of the parallel dividers towards the proximal end of the extruder die is between about 5% to 100% the length of the extruder attachment portion.

### Example 26

The extruder die of any one of claims 6-25, wherein the extruder die comprises the tapering portion.

### Example 27

The extruder die of any one of claims 6-26, wherein the extension of the parallel dividers extends into the tapering portion.

### Example 28

The extruder die of any one of claims 6-27, wherein the vertical height to lateral width ratio of the plurality of adjacent slit openings is adjustable.

### Example 29

The extruder die of any one of claims 6-28, wherein the vertical height to lateral width ratio of the plurality of adjacent slit openings suppresses vertical expansion and promotes lateral expansion.

### Example 30

The extruder die of any one of claims 6-29, wherein the vertical height to lateral width ratio of the plurality of adjacent slit openings is sufficient to produce an asymmetrical pore morphology.

### Example 31

The extruder die of any one of claims 6-30, wherein the output orifice has a lateral width in the range of between 0.5 to 8 feet.

### Example 32

The extruder die of any one of claims 6-31, wherein the output orifice has a vertical height in the range of between ⅕ to 1/10 of the required thickness of the produced polymer sheet after expansion.

### Example 33

The extruder die of any one of claims 6-32, wherein the output orifice has a vertical height in the range of between 0.05 to 2 inches.

### Example 34

The extruder die of any one of claims 6-33, wherein the output orifice has a lateral width to vertical height ratio in the range of between 100:1 to 3,000:1.

### Example 35

The extruder die of any one of claims 6-34, wherein the extruder die reduces polymer melt swelling and gas expansion in the direction normal to the polymer sheet surface.

### Example 36

The extruder die of any one of claims 6-35, wherein the width to length ratio of the plurality of adjacent slit openings is used to control the polymer melt swelling and subsequent gas expansion ratio.

### Example 37

The extruder die of any one of claims 6-36, wherein the extruder die applies an external compression in the vertical direction and an external tension in the lateral direction.

### Example 38

The extruder die of claim 37, wherein the external compression and external tension increases the gas expansion ratio in the lateral direction.

### Example 39

The extruder die of claim 37 or 38, wherein the external compression and external tension increases the thermal insulation value in the vertical (normal) direction.

### Example 40

The extruder die of any one of claims 6-39, wherein the distal portion of the extruder attachment portion, comprising the plurality of parallel dividers and the plurality of adjacent slit openings, is a separate unit attachable to an extruder head.

### Example 41

The extruder die of any one of claims 6-40, wherein the distal portion of the extruder attachment portion, comprising the plurality of parallel dividers and the plurality of adjacent slit openings, is a separate unit detachable from an extruder head.

### Example 42

A method of producing a polymer sheet having an asymmetrical pore morphology, comprising extruding polymer material through the extruder die of any one of claims 6-41.

### Example 43

A method of producing a polymer sheet having an asymmetrical pore morphology, comprising:

extruding polymer material through an extruder die opening having an elongated output orifice partitioned by a plurality of parallel dividers defining a plurality of adjacent slit openings extending transversally across the length of the elongated output orifice.

### Example 44

A method for manufacturing an article comprising a polymer material system with at least 95% porosity comprising greater than 10% asymmetrical pores, comprising:

extruding polymer material through an extruder die opening having an output orifice partitioned by a plurality of parallel dividers defining a plurality of adjacent slit openings each having a vertical height greater than a lateral width.

### Example 45

The method of any one of claims 42-44, wherein gas embryos within the extruding polymer material asymmetrically expand in a controlled fashion so that the asymmetrical pores formed within the expanded polystyrene insulation panel are aligned in a preferred direction.

### Example 46

The method of any one of claims 42-45, wherein the asymmetrical pores are formed by gas foaming expansion of gas embryos in the extruding polymer material.

### Example 47

The method of any one of claims 42-46, wherein the gas foaming is a continuous foam extrusion process.

### Example 48

The method of any one of claims 42-47, wherein the gas foaming is an asymmetrical expansion of the pores in the polymer system.

### Example 49

The method of any one of claims 42-48, wherein the gas foaming asymmetrical expansion is controlled so that the asymmetrical pores are aligned in a preferred direction.

### Example 50

The method of any one of claims 42-49, wherein the forming of the asymmetrical pore morphology is facilitated by using an inorganic filler as a template for the formation of the one or more gas nuclei.

### Example 51

The method of any one of claims 42-50, wherein pre-foaming pore development and alignment initiates during passage through the extruder attachment portion.

### Example 52

An article of manufacture having an asymmetrical pore morphology produced by any one of the methods of claims 42-51.

### Example 53

An article of manufacture, comprising a polymer material system with at least about 90% porosity and having greater than about 10% asymmetrical pores.

### Example 54

The article of manufacture of claim 52 or 53, wherein the asymmetrical pores have a disc-shape pore morphology.

### Example 55

The article of manufacture of any one of claims 52-54, wherein the asymmetrical pore morphology is expanded in both lateral and machine directions while suppressed in vertical direction.

### Example 56

The article of manufacture of any one of claims 52-55, wherein the manufactured article comprises nanopores having a pore size no greater than 1500 nanometers in its shortest axis.

### Example 57

The article of manufacture of any one of claims 52-56, wherein greater than 50% of the nanopores have a pore size no greater than 1500 nanometers in its shortest axis.

### Example 58

The article of manufacture of any one of claims 52-57, wherein the manufactured article comprises greater than 25% asymmetrical pores.

### Example 59

The article of manufacture of any one of claims 52-58, wherein the manufactured article is an expanded polystyrene insulation panel having a thickness between 0.5 inches to 8 inches, a width between 1 foot to 10 feet and a length greater than the width.

### Example 60

The article of manufacture of any one of claims 52-59, wherein the expanded polystyrene insulation panel comprises nanopores having a pore size no greater than 1500 nanometers in its shortest axis.

### Example 61

The article of manufacture of any one of claims 52-60, wherein the expanded polystyrene insulation panel comprises greater than 25% asymmetrical pores.

### Example 62

The article of manufacture of any one of claims 52-61, wherein asymmetrical pores within the expanded polystyrene insulation panel are aligned in a preferred direction.

### Example 63

The article of manufacture of any one of claims 52-62, wherein the pore geometry is oriented such that the short axis of the pores are aligned in a direction normal to the lateral-machine planar surface of the polymer sheet.

### Example 64

The article of manufacture of any one of claims 52-63, wherein the asymmetrical pores have an oblate or prolate pore geometry.

### Example 65

The article of manufacture of any one of claims 52-64, wherein greater than 25% of the nanopores are oblate or substantially oblate nanopores.

### Example 66

The article of manufacture of any one of claims 52-65, wherein greater than 25% of the nanopores are prolate or substantially prolate nanopores.

### Example 67

The article of manufacture of any one of claims 52-66, wherein one or more of the nanopores have its longest axis oriented normal to the application direction or substantially normal to the application direction.

### Example 68

The article of manufacture of any one of claims 52-67, wherein one or more of the nanopores have its shortest axis oriented along the application direction or substantially along the application direction.

### Example 69

The article of manufacture of any one of claims 52-68, wherein one or more of the nanopores have its longest axis oriented normal to the thermal gradient direction or substantially normal to the thermal gradient direction.

### Example 70

The article of manufacture of any one of claims 52-69, wherein greater than 25% of the nanopores have its longest axis oriented normal to the thermal gradient direction or substantially normal to the thermal gradient direction.

### Example 71

The article of manufacture of any one of claims 52-70, wherein one or more of the nanopores have its longest axis oriented along to the machine direction or substantially along to the machine direction.

### Example 72

The article of manufacture of any one of claims 52-71, wherein one or more of the nanopores have its shortest axis oriented normal the machine direction or substantially normal the machine direction.

### Example 73

The article of manufacture of any one of claims 52-72, wherein the manufactured article comprises greater than 25% of nanopores with secondary, tertiary and/or quaternary structure.

### Example 74

The article of manufacture of any one of claims 52-73, wherein the manufactured article comprises a thermal insulation value greater than 6 R/inch.

### Example 75

The article of manufacture of any one of claims 52-74, wherein the manufactured article comprises a thermal conductivity value less than 30 mW/M° K.

### Example 76

The article of manufacture of any one of claims 52-75, wherein the manufactured article is a polymer sheet.

### Example 77

The article of manufacture of any one of claims 52-76, wherein the manufactured article is an insulation panel.

### Example 78

The article of manufacture of any one of claims 52-77, wherein the manufactured article is an XPS foam panel.

### Example 79

The article of manufacture of any one of claims 52-78, wherein the nanopores are formed by gas foaming expansion of gas embryos in the extruding polymer material.

### Example 80

The article of manufacture of any one of claims 52-79, wherein the gas foaming is a continuous foam extrusion process.

### Example 81

The article of manufacture of any one of claims 52-80, wherein the gas foaming is an asymmetrical expansion of the pores in the polymer system.

### Example 82

The article of manufacture of any one of claims 52-81, wherein the gas foaming asymmetrical expansion is controlled so that the asymmetrical pores are aligned in a preferred direction.

### Example 83

The article of manufacture of any one of claims 52-82, wherein the forming of the asymmetrical pore morphology is facilitated by using an inorganic filler as a template for the formation of the one or more gas nuclei.

### Example 84

The article of manufacture of any one of claims 52-83, wherein the inorganic filler is a modified clay to form a polymer-clay composite.

### Example 85

The article of manufacture of any one of claims 52-84, wherein the modified clay is an exfoliated clay.

### Example 86

The article of manufacture of any one of claims 52-85, wherein the inorganic filler is aligned along the machine direction in a continuous foam extrusion process.

### Example 87

The article of manufacture of any one of claims 52-86, wherein an internal tension field is created and maintained by addition of a compatible elastomer.

### Example 88

The article of manufacture of any one of claims 52-87, wherein the compatible elastomer in a polystyrene polymer system is SEBS.

### Example 89

The article of manufacture of any one of claims 52-88, wherein the addition of the compatible elastomer enhances creation of one or more gas nuclei by homogenous nucleation under reduced pressure or tension.

### Example 90

The article of manufacture of any one of claims 52-89, wherein the polymer sheet is an insulation material.

### Example 91

The article of manufacture of any one of claims 52-90, wherein the insulation material is created by a foaming process embedded within a polymer extrusion, or injection molding process.

### Example 92

The article of manufacture of any one of claims 52-91, wherein the polymer comprises polystyrene, polyurethanes, polyethylene, polypropylene, polyethylene terephthalate, or a polymer blend thereof.

### Example 93

The article of manufacture of any one of claims 52-92, wherein the polymer may be foamed to a low density.

### Example 94

The article of manufacture of any one of claims 52-93, wherein the polymer is a polymer blend.

### Example 95

A new generation of thermal insulation material produced by a polymer foaming process comprising and made from any, or a combination of, the following features:
(a) generating homogeneously smaller gas nuclei or domains by a homogeneous nucleation or spinodal decomposition, using primarily CO2, or a similar inert gas, as a foaming agent such that the gas bubbles' geometry and orientation may be manipulated during their growth through controlled gas expansion,
(b) growing asymmetrical (oblate or prolate) pore morphology,
(c) orienting asymmetrical (oblate or prolate) pores with their shortest axis along the insulation application (i.e. the temperature gradient) direction.

### Example 96

The article of Example 95, wherein the prescribed pore geometry (i.e. oblate, or prolate) and orientation (shortest axis is aligned in the direction normal to insulation board surface) are created by a die configuration design that reduces polymer melt swelling and gas expansion in the direction normal to the insulation board surface.

### Example 97

The article of any one of Examples 95-96, wherein the die is configured to have parallel slits of which the aspect ratio (width to length ratio) is used to control the polymer melt swelling and subsequent gas expansion ratio.

### Example 98

The article of any one of Examples 95-97, wherein a die housing is attached for applying external compression (in vertical direction) and tension (in lateral direction) to further increase the expansion ratio in the lateral direction and consequently, the thermal insulation value in normal direction.

### Example 99

The article of any one of Examples 95-98, wherein an internal tension field is created and maintained by the addition of a compatible elastomer (for example, but not limited to, adding SEBS into polystyrene) to withstand a higher pressure drop at the die exit and, thereby, enhance creation of more gas nuclei by homogenous nucleation under reduced pressure, or tension.

### Example 100

The article of any one of Examples 95-99, wherein the insulation material is created by a foaming process embedded within a polymer extrusion, or injection molding process.

### Example 101

The article of any one of Examples 95-100, wherein said polymer material is polystyrene, polyurethanes, polyethylene, polypropylene, polyethylene terephthalate that may be foamed to a low density.

### Example 102

The article of any one of Examples 95-101, wherein the polymer material is a blend of polymers of Example 101.

### LIST OF REFERENCES

### Each of which are Incorporated Herein by Reference in their Entirety

1. Yang, A. J., Armstrong World Industries, Internal Publication, Oct. 7, 1986.
2. Yang, A. J., Armstrong World Industries, Internal Publication, Apr. 3, 1990.
3. “Thermal Insulation Materials-Morphology Control and Process for the Next Generation of Performance”, Advanced Technology Program (Department of Commerce) award to Armstrong World Industries, Inc., 1992.
4. Hager, N. E. Jr., Technical Report, Armstrong Cork, Dec. 16, 1958.
5. Hashin, Z, J., Composite Materials, 2(3), 284 (1968).
6. Torquato, S., Sen, A. K.; J. Appl. Phys. 67(3), 1145 (1989).
7. Torquato, S., Appl. Mech. Rev., 44(2), 37 (1991).
8. “Mixing Plate-Like and Rod-Like Molecules with Solvent: A Test of Flory-Huggins Lattice Statistics”, E. A. DiMarzio, A. J. Yang, and Sharon C. Glotzer, J. Res. Natl. Inst. Stand. Technol., 100, 173 (1995).

All publications and patent applications mentioned in this specification are herein incorporated by reference to the same extent as if each individual publication or patent application was specifically and individually indicated to be incorporated by reference.

While preferred embodiments of the present invention have been shown and described herein, it will be obvious to those skilled in the art that such embodiments are provided by way of example only. It is intended that the following claims define the scope of the invention and that methods and structures within the scope of these claims and their equivalents be covered thereby.

1. A foam extrusion slot die comprising a plurality of parallel dividers extending transversely across the slot, wherein the plurality of dividers define a plurality of adjacent rectangular slit openings each having a length extending perpendicularly across the lateral length of the slot die.

2. An extruder die for producing a foamed polymer sheet, comprising:
i) an extruder attachment portion proximate the proximal end of the extruder die, for attaching to an extruder;
ii) an elongated orifice, proximate the distal end of the extruder die, wherein the elongated orifice is partitioned by a plurality of parallel dividers defining a plurality of adjacent rectangular slit openings extending transversally across the length of the elongated orifice; and
iii) an optional tapering portion connecting the extruder attachment portion and the elongated orifice.

3. The extruder die of claim 1, wherein the longest length of the rectangular orifices extends transverse to the plane.

4. The extruder die of claim 1, wherein the plurality of parallel dividers transversely extend from the output orifice towards the proximal end of the extruder die in sufficient length to form an asymmetrical pore morphology in the foamed polymer sheet.

5. The extruder die of claim 4, wherein the asymmetrical pore morphology is expanded in both lateral and machine directions while suppressed in vertical direction.

6. The extruder die of claim 1, wherein the vertical height to lateral width ratio of the plurality of adjacent slit openings suppresses vertical expansion and promotes lateral expansion.

7. The extruder die of claim 1, wherein the vertical height to lateral width ratio of the plurality of adjacent slit openings is sufficient to produce an asymmetrical pore morphology.

8. The extruder die of claim 1, wherein the output orifice has a vertical height in the range of between ⅕ to 1/10 of the required thickness of the produced polymer sheet after expansion.

9. A method of producing a polymer sheet having an asymmetrical pore morphology, comprising extruding polymer material through the extruder die of claim 1.

10. A method for manufacturing an article comprising a polymer material system with at least 95% porosity comprising greater than 10% asymmetrical pores, comprising:
extruding polymer material through an extruder die opening having an output orifice partitioned by a plurality of parallel dividers defining a plurality of adjacent slit openings each having a vertical height greater than a lateral width.

11. An article of manufacture having an asymmetrical pore morphology produced by the methods of claim 9.

12. An article of manufacture, comprising a polymer material system with at least about 90% porosity and having greater than about 10% asymmetrical pores.

13. The article of manufacture of claim 11, wherein the asymmetrical pores have a disc-shape pore morphology such that the asymmetrical pore morphology is expanded in both lateral and machine directions while suppressed in vertical direction.

14. The article of manufacture of claim 11, wherein the manufactured article is an expanded polystyrene insulation panel having a thickness between 0.5 inches to 8 inches, a width between 1 foot to 10 feet and a length greater than the width.

15. The article of manufacture of claim 11, wherein the expanded polystyrene insulation panel comprises nanopores having a pore size no greater than 1500 nanometers in its shortest axis.
